(19) United States
(12) Patent Application Publication
(10) Pub. No.: US 2009/0059590 A1
(43) Pub. Date: Mar. 5, 2009

(54) Portable surface skimming illumination device for locating small items on a planar surface

(76) Inventor: Richard J. Quattrini, JR., San Jose, CA (US)

Correspondence Address: FOOTHILL LAW GROUP, 777 N. FIRST STREET, SUITE 325, SAN JOSE, CA, 95112, US

(21) Appl. No.: 11/847,274

(22) Filed: Aug. 29, 2007

(51) Int. Cl. F21S 6/00

(52) U.S. Cl. 362/257

(57) ABSTRACT

This invention describes a light source that is designed to illuminate a floor or other flat work surface for the purpose of locating small hard to see objects. This can be for the purpose of cleaning or simply locating a small valuable object. The light source is fashioned such that it provides a very low grazing angle of illumination that it skims across a surface. Small objects or particles are visible as being brighter than the surroundings and set off by a long shadow on the side of the particle away from the light.

### BACKGROUND OF THE INVENTION

1. Field of the Invention

The field of the invention is portable high intensity light sources of a type which will illuminate a planar surface with a low angle of illumination that skims along the planar surface. Such a device is particularly useful for locating very small hard to find items.

2. Description of the Prior Art

Flashlights and portable lighting devices are well known in the prior art. Such devices sometimes are modified to suit a specific purpose or are adjustable to suit a variety of purposes. Portable flashlights are often classified as either “spot” lights or “flood” lights depending on whether the beam is focused into a narrow beam or defocused to cover a wider area. Flood lights are sometimes referred to as area lights, especially when there is some attempt to shape the beam to light a specific area. In some cases lights contain both a spot and flood light or have a means for adjusting the spread of the beam to achieve either effect or a variant in between.

Typical uses for these lights are for seeing in places where the existing ambient light does not fall. This may include looking under stairs, deep in a closet, deep in a cabinet, under a couch, under a workbench, or for looking around a backyard at night. Flashlights are also kept on hand for emergency purposes such as a power failure or for signaling someone in the dark to alert them.

To date, the previous art has not described a flashlight designed and optimized for highlighting small hard to see items, such as broken glass, dropped contact lenses or the backs of earrings. The instant invention describes a light specifically designed to provide a highly intense but uniform beam of light designed for highlighting small items on a floor or other flat surface.

For many years the concept of illuminating an object with a low grazing angle has been used in microscopy and industrial machine vision applications for the purpose highlighting defects or particles on relatively flat surfaces. This is sometimes referred to as “dark field illumination.” The fundamental concept is to use lighting at an angle to the surface such that anything that sits on or protrudes from the surface will scatter light up to an eye, a detector or a camera. Light that is reflected directly from the surface itself will never reach the eye, detector or camera. For noisy backgrounds or difficult to see objects, this concepte can be taken to extremes such that the illumination source is at a very low grazing angle with respect to the surface. This can form an even higher contrast between surface and any objects on the surface so that they can easily be detected. The low grazing angle minimizes any reflection from the flat surface while maximizing the reflection from the objects on the surface. In cases where the illumination is coming from a single direction, any objects on the surface will also cast a long shadow behind the object thus making them easier to find. Grazing angle is defined as the angle between a light beam and a surface (i.e. 90 degrees minus the angle of incidence).

Systems have been described to locate small or submerged items with light or radar in marine systems using low grazing angle incident radiation.

U.S. Patent Application 20070035624 by Lubard, et al, discloses a system and for detection of objects that are submerged, or partially submerged (e. g. floating), relative to a water surface. One aspect of the invention is the use of Light Detection and Ranging (LIDAR) emitting nearly horizontal pulses to illuminate small exposed objects at tens of kilometers, detecting successive reflected portions and images with a streak-tube subsystem. The prior art further describes an experimental deployment shown by Anderson, Howarth and Mooradian (“Grazing Angle LIDAR for Detection of Shallow Submerged Objects”, Proc. International Conference on Lasers, 1978) for shallow angle marine observation at short range.

U.S. Patent Application 20060273946 to Krikorian et al, discloses a radar system where the target is illuminated from a plurality of locations to generate images at many aspect angles. The radar is positioned at a low grazing angle with respect to the target for generating a shadow of the target on the flat or sloping terrain for each aspect angle of the plurality of aspect angles.

U.S. Pat. No. 6,836,285 to Lubard, et al, discloses a LIDAR system or other means at an elevated position emit thin fan-beam light pulses at a shallow angle, and detect reflected portions of the pulses at a like angle in marine systems. Preferably the shallow angle is in a range of approximately one to fifteen degrees, more preferably approximately two to ten degrees, ideally roughly five degrees.

U.S. Pat. No. 4,926,299 by Warren E. Gilson describes a “portable flashlight” that provides a reflector which provides non-glare illumination of a relatively small rectangular area such as along a sidewalk or stair tread. The primary object of this is to provide a uniformly lit area generally without intense glare. The flashlight also contains a mode that more focused high intensity spot light. While a light of this nature may conceivably be used in a low grazing angle situation, either mode will be sub-optimal for the purpose of highlighting small objects on a flat surface.

In the area mode, the rectangular area illuminated is described as being “small and generally without intense glare.” The area mode is designed to project a rectangular shaped beam in an axis perpendicular to the optical axis of the beam (reference FIG. 6 in U.S. Pat. No. 4,926,299). In order to be strong enough to highlight small particles or objects, the beam would need to be of high intensity and focused in a manner that would provide uniform light on the floor when projected at a low grazing angle more along an axis directed toward to the floor.

In the spotlight mode, the flashlight may have enough intensity to highlight small particles if held at an appropriate angle to the floor. Unfortunately there will need to be significant manipulation by the user to get the angle correct. Additionally, the narrow nature of a spotlight beam will require the user to perform much more manual “scanning” of the surface to view a wide area.

U.S. Pat. No. 4,605,994 to Rudolf Krieg describes a “flash lamp” with essentially uniform illumination respective of spot and flood fields. This flashlight is interesting in that it can be adjusted to achieve varying intensities and beam spreads with highly uniform results perpendicular to the primary optical axis. Again, by holding this flashlight close to the floor and manipulating it, it may effectively highlight small particles or objects. Unfortunately this lamp is optimized to provide a circularly uniform pattern perpendicular to the primary axis. The overall shape of the beam will be inefficient when projected at angles nearly parallel to the floor. The end result will be a very elongated oval brightly lit area across the floor. This can be useful, but tedious in that it will require significant manual scanning to inspect a wide area for the purpose of locating small particles.

U.S. Pat. No. 4,414,612 describes a flashlight that not only adjusts the beam width but also the orientation of the head. This flashlight has a flat bottom surface such that it could be placed flat on a floor. With the adjustable head orientation it may be possible to find a position that works better that a normal flashlight for low grazing angle illumination, albeit not optimized. Where this light falls short is in the shaping of the beam for the application. Like most flashlights this contains a parabolic reflector that is circularly symmetric (i.e. it provides a relatively circular shaped beam perpendicular to the primary optical axis). The pattern it projects while grazing across a flat surface will not be efficiently optimized for high intensity light across a wide area of the floor (again, a very elongated illumination pattern).

U.S. Pat. No. 2,889,450 describes a casing for a lighting device that has edges of varying angles such that the beam can be directed in one of several directions when set on a flat surface. One of these directions is parallel to the floor. Having the beam perfectly parallel to the floor is not effective as most of the emitted light will actually not strike the floor. The light needs to be near parallel directed at a slight angle toward the floor. The other positions available on this lamp direct light away from the floor and are not suitable for the purpose of locating small items. This light also suffers from the same deficiency as the previous lights in that the projected beam shape will be circular in a plane perpendicular to the optical axis.

There is a need for a portable illuminator which will optimally illuminate small items on a planar surface.

There is a need for an illuminator capable of resting flat on a planar surface and providing a high intensity, uniform illumination of the surface in an area extending from immediately adjacent to the light and for a further distance from the light, wherein said illumination is characterized by a low grazing angle that will illuminate small items on the surface. The light will also cast a long shadow behind any object (on the side opposite the light source).

There is a need for a portable illuminator capable of resting flat on a planar surface and providing a high intensity, uniform illumination of the surface in an area extending from immediately adjacent to the light and for a further distance from the light, wherein said illumination is characterized by a grazing angle less than 10 degrees.

There is a need for a portable illuminator capable of resting flat on a planar surface and providing a high intensity, uniform illumination of the surface in an area extending from immediately adjacent to the light and for a further distance from the light, wherein said illumination is characterized by a grazing angle less than 6 degrees.

### SUMMARY OF THE INVENTION

One preferred embodiment of the invention is a portable illuminator which is well suited to illuminate a floor or other planar surface for the purpose of locating small, hard to see items, including but not limited to finding glass, small shards or debris, contact lenses, earring backs, tiny screws, and the like. It does this by producing a very low grazing angle illumination that skims across the planar surface. For the purposes of this application grazing angle is defined as the angle between a light beam and a surface (i.e. 90 degrees minus the angle of incidence).

The instant invention builds on the concept of dark field illumination which has been used for microscopy and industrial machine vision applications to highlight defects on flat surfaces. The fundamental concept is to use lighting at an angle to the surface such that anything that sits on or protrudes from the surface will scatter light upwards to an eye, a detector or a camera. Light that is reflected directly from the surface will never reach the eye, detector or camera.

For noisy backgrounds or difficult to see objects, the concept of dark field illumination can be taken to extremes such that the illumination source is at a very low grazing angle with respect to the surface. This can form an even higher contrast between surface and any objects on the surface so that they can easily be detected.

With a properly designed portable illuminator, a low grazing angle dark field concept can be applied for the simple application of locating broken glass, dirt, or other small objects on a floor or flat surface. If a person is looking down onto a floor or flat surface that is illuminated with low grazing angle illumination, the person will observe the same affect light scattering effect that a camera or detector would. The light scattering from any object sitting on the surface will be much brighter than any light reflected from the surface. Furthermore, if the illumination is coming from only one direction, a long shadow will be cast immediately behind any object in the path of the light. This long shadow provides further contrast of normally hard to see particles on a surface.

A portable illuminator according to the invention comprises:
a) a body capable of resting flat on a planar surface,
b) at least one high intensity light source mounted in the body,
c) at least one light shaping means mounted in the body, capable of providing high intensity, uniform illumination of the surface in an area extending from immediately adjacent to the illuminator and for a further distance from the illumination, wherein said illumination is characterized by a low grazing angle, and
d) whereby said high intensity light is focused at an angle nearly parallel to the surface.

Several embodiments of the light shaping means comprise a reflector, a reflector in series with a cylindrical lens, and a reflector in series with a fresnel lens.

A low grazing angle may be less than 30 degrees, preferably less than 10 degrees and more preferably less than 6 degrees.

A high intensity light produces 700-5000 lux and more preferably 800-5000 lux at a distance of up to 5 feet from the source and preferably at least 10 feet.

The light is used by putting the light flat on the surface and allowing the light to illuminate the surface, and look for small articles on the surface. The light may be systematically moved from place to place until the entire surface is inspected.

It is an object of the invention to supply a portable illuminator which will optimally illuminate small items on a planar surface.

It is a further object of the invention to supply a portable illuminator capable of resting flat on a planar surface and providing a high intensity, uniform illumination of the surface in an area extending from immediately adjacent to the light and for a further distance from the light, wherein said illumination is characterized by a low grazing angle that will illuminate small items on the surface. The light will also cast a long shadow behind any object (on the side opposite the light source).

It is a still further object of the invention to supply a portable illuminator capable of resting flat on a planar surface and providing a high intensity, uniform illumination of the surface in an area extending from immediately adjacent to the light and for a further distance from the light, wherein said illumination is characterized by a grazing angle less than 10 degrees.

### BRIEF DESCRIPTION OF THE DRAWINGS

These and other features, aspects and advantages of the present invention will become better understood with regard to the following description, appended claims and accompanying drawings, where:

FIG. 1a is a view of a typical prior art flashlight.

FIG. 1b is a view of the resulting beam pattern from the prior art flashlight.

FIG. 2a is a side view of one preferred embodiment of the invention.

FIG. 2b is a top view of the same embodiment.

FIG. 2c is a side view of an embodiment with two light producing structures.

FIG. 2d is a top view of the embodiment in 2c.

FIG. 3 shows top, side, and front views of the light producing structure comprising a reflector and a cylindrical lens.

FIG. 4 shows top, side, and front views of the light producing structure comprising a reflector and a fresnel lens.

FIG. 5 shows top, side, and front views of the light producing structure comprising a reflector and a piano lens.

### DESCRIPTION OF THE PREFERRED EMBODIMENTS

One preferred embodiment of the invention is a portable illuminator which is well suited to illuminate a floor or other planar surface for the purpose of locating small, hard to see items, including but not limited to finding glass, small shards or debris, contact lenses, earring backs, tiny screws, and the like. It does this by producing a very low grazing angle illumination that skims across the planar surface. For the purposes of this Application, grazing angle is the angle between a light beam and a surface (i.e. 90 degrees minus the angle of incidence).

With a properly designed portable light, a low grazing angle can be applied for the simple application of locating broken glass, dirt, or other small objects on a floor or flat surface. If a person is looking down onto a floor or flat surface that is illuminated with uniform low grazing angle light will observe that the light reflected from small objects will be much brighter than the light reflected from the surface. Furthermore, if the illumination is coming from only one direction, a long shadow will be cast immediately behind any object in the path of the light. This long shadow provides further contrast of normally hard to see particles on a surface and sets off the small object.

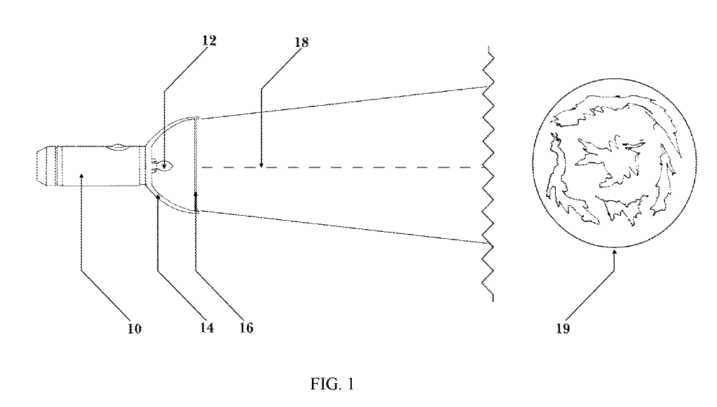

Moving to the Figures, FIG. 1 shows a prior art flashlight. Note that it is not configured to cast a uniform light on a surface below such as the floor. It comprises a body 10, a light bulb 12, within the body, a parabolic reflector 14, cover 16 and an optical axis 18. It produces a beam pattern 19, which is characterized by relatively dark and relatively light spots.

Several disadvantages of prior art flashlights with respect to the task of locating small items on a surface are noted:
(1) General purpose flashlights are designed to emit a beam of light that is somewhat divergent in all axis's perpendicular to the primary axis of the beam (i.e. over a distance the spot tends to get larger to illuminate lager areas)
(2) The beam pattern tends to be somewhat symmetric around the optical axis, the beam profile is not optimized to focus most of the light so that it skims across a surface
(3) Since the flashlight does not sit flat on the surface, the user needs to bend over and provide excess manipulation to ensure that a high intensity portion of the beam is skimming across the floor
(4) Most flashlights have significant hot and cold spots on the illuminated area (i.e. there is a great deal of fluctuation of the beam brightness across the field being illuminated).
(5) Flashlights that have enough intensity for this application work typically have larger round reflectors (3″-6″) making it difficult to get the brightest spot of the source (in the center) very close to the surface.

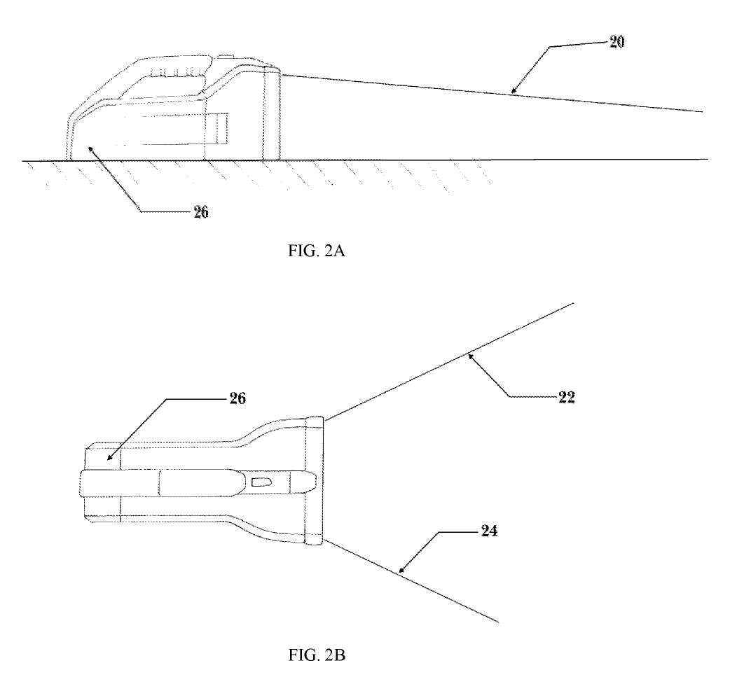

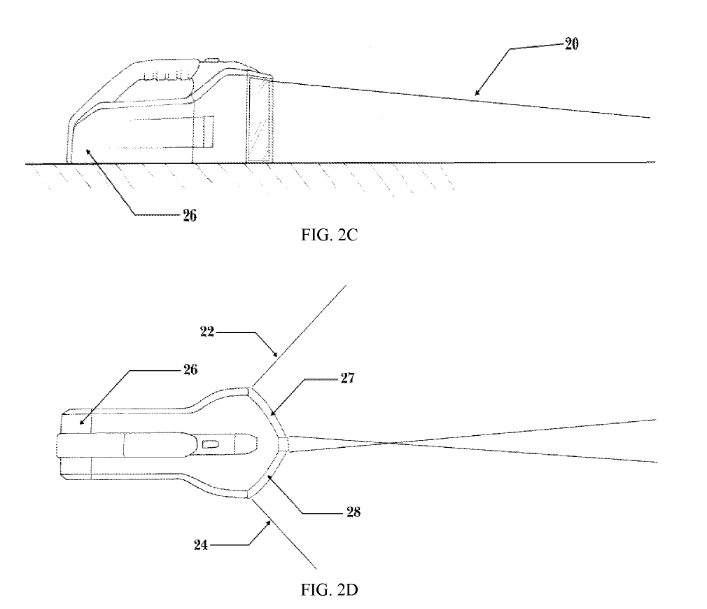

FIGS. 2A and 2B show the side and top views respectively of the outside of the body 26 of a preferred portable surface skimming illuminator according to the invention. Notice that in FIG. 2A, the illuminator body sits flat on the floor and in the vertical the beam profile 20 is focused to skim across the floor at a small grazing angle. In the horizontal, the beam 22 and 24 is divergent to illuminate a wider area than the illuminator itself.

FIGS. 2c and 2d are similar to 2a and 2b, except that there is a much wider divergent beam between rays 22 and 24 on FIG. 2d, due to having 2 light producing structures 27 and 28.

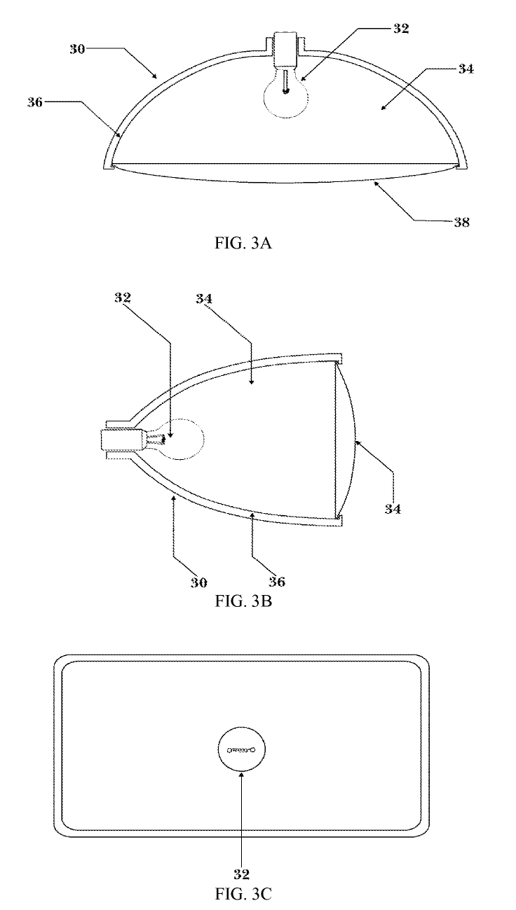

FIG. 3 shows the side, top, and front views of the light producing structure of one preferred embodiment of the illuminator. The illuminator comprises: a body 30 capable of resting flat on a planar surface (shown in the drawing is the front part of the whole body 26 shown in FIGS. 2A and 2B), a high intensity light 32 source mounted in the body, and a light shaping means 34 mounted in the body, capable of providing high intensity, uniform illumination of the surface in an area extending from immediately adjacent to the light and for a further distance from the light. The illumination is characterized by a low grazing angle to the surface. In this case the light shaping means comprises an internal reflector 36, and a cylindrical lens 38.

A low grazing angle is preferably less than 30 degrees more preferably less than 10 degrees, and most preferably between to 6 degrees and 0 degrees (inclusive), where 0 is a beam of light parallel to the floor.

High intensity uniform lighting refers to the brightness of the light being at least 700 lux on the floor at a distance from less than one foot and to at least 5 feet from the source. More preferably the brightness should be greater than 2500 lux and most preferably greater than 5000 lux. It is most preferable to cast the beam on the floor at distances up to 5 feet, most preferably at least 10 feet.

The illuminator body is preferably made by injection molding plastic. The construction is conventional and will be well known to those skilled in the art. Similarly, the optics of the lens and reflector is conventional for a particular size of illuminator and will be calculated by ordinary physics.

The light source can be of any type. Some examples include incandescent, tungsten, krypton, xenon, LED's, LED arrays, scanning lasers, and equivalents thereto. An important aspect here is that the light source is preferably within about zero to six inches of the surface such that can be positioned close enough to the surface to form a low grazing angle and is shaped or focused for uniform lighting that skims across the surface. There can also be multiple light sources within one device to provide a wider area of coverage.

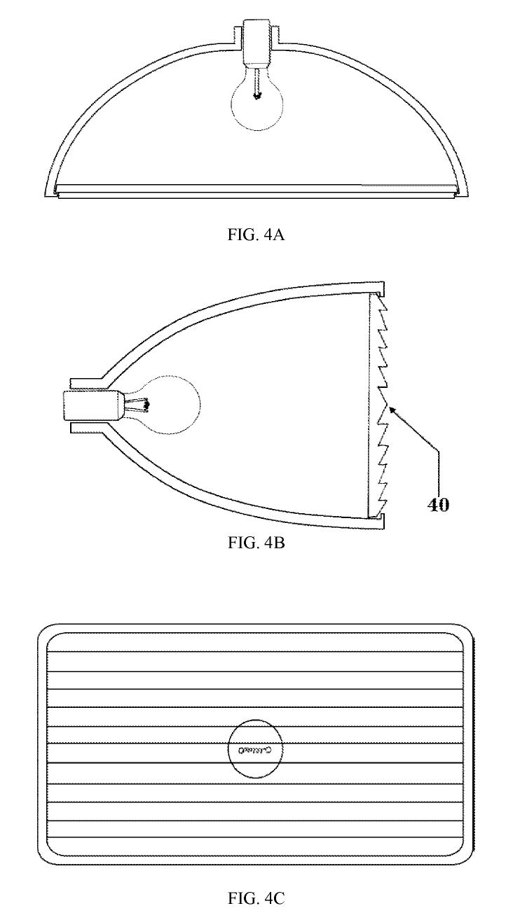

FIG. 4 shows an alternative embodiment, with the shaping means comprising a reflector and a fresnel lens 42 in place of the cylindrical lens 38 in FIG. 3, and which is otherwise identical to FIG. 3.

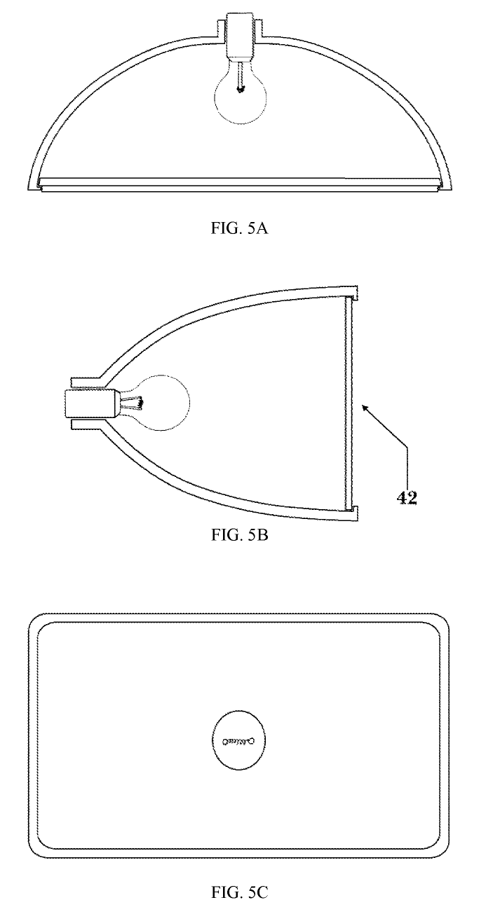

FIG. 5 shows another alternative embodiment, with the shaping means comprising a reflector and a piano lens 42 in place of the cylindrical lens 38 in FIG. 3, and the fresnel lens 42 in FIG. 4, and which is otherwise identical to FIGS. 3 and 4.

Although the present invention has been described in considerable detail with reference to certain preferred versions thereof, other versions are possible. Therefore the spirit and scope of the appended claims should not be limited to the preferred versions herein.

1. A portable illuminator, comprising
a) a body which is capable of resting flat on a planar surface,
b) at least one high intensity light source mounted within the body,
c) at least one light shaping means mounted in the body, which means is capable of providing high intensity, uniform illumination of the surface in an area extending from immediately adjacent to the illuminator and for a further distance from the illuminator, wherein said illumination is characterized by a low grazing angle, and
d) whereby said high intensity light is focused at an angle nearly parallel to the surface and wherein said low grazing angle is less than 30 degrees.

2. The portable illuminator of claim 1, wherein said light shaping means comprises a reflector and a lens.

3. The portable illuminator of claim 2, wherein the lens comprises a cylindrical lens.

4. The portable illuminator of claim 1, wherein said light shaping means comprises a reflector.

5. The portable illuminator of claim 2, wherein the lens is a fresnel lens.

6. (canceled)

7. The portable illuminator of claim 1, wherein the grazing angle is less than 10 degrees.

8. The portable illuminator of claim 7, wherein the grazing angle is in the range between six and zero degrees inclusive.

9. The portable illuminator of claim 1, wherein the illumination of the surface is at least 700 lux on the surface at a distance from less than one foot to at least 5 feet from the portable illuminator.

10. The portable illuminator of claim 1, wherein the illumination of the surface is at least 2500 lux on the surface at a distance from less than one foot to at least 5 feet from the portable illuminator.

11. The portable illuminator of claim 1, wherein the illumination of the surface is at least 5000 lux on the surface at a distance from less than one foot to at least 5 feet from the portable illuminator.

12. The portable illuminator of claim 1, wherein the illumination of the surface is at least 700 lux on the surface at a distance from less than one foot to at least 10 feet from the portable illuminator.

13. The portable illuminator of claim 1, wherein the illumination of the surface is at least 2500 lux on the surface at a distance from less than one foot to at least 10 feet from the port able illuminator.

14. The portable illuminator of claim 1, wherein the illumination of the surface is at least 5000 lux on the surface at a distance from less than one foot to at least 10 feet from the port able illuminator.

15. The portable illuminator of claim 1, wherein said high intensity light source is positioned close enough to the surface to form a beam on the surface with low grazing angle.

16. The portable illuminator of claim 15, wherein said portable illuminator high intensity light source is in the range between zero and six inches above the planar surface when the portable illuminator sits on the planar surface.

17. The portable illuminator of claim 1, wherein said high intensity light source comprises a light chosen from the group consisting of incandescent, tungsten, krypton, xenon, LED's, LED arrays, scanning lasers, and equivalents thereto.

18. The portable illuminator of claim 1, wherein said at least one high intensity light source comprises at least two high intensity light sources.

19. The portable illuminator of claim 18, wherein said at least one light shaping means comprises at least two light shaping means.

20. A portable illuminator, comprising:
a) a body which is capable of resting flat on a planar surface,
b) at least one high intensity light source mounted within the body,
c) at least one light shaper mounted in the body to provide high intensity, uniform illumination of the surface in an area extending from immediately adjacent to the illuminator and for a further distance from the illuminator, wherein said illumination is characterized by a low grazing angle less than 30 degrees, and
d) whereby said high intensity light is focused at an angle nearly parallel to the surface.

21. The portable illuminator of claim 20, wherein the lens comprises a fresnel lens.
